(19) United States
(12) Patent Application Publication
(10) Pub. No.: US 2018/0310760 A1
(43) Pub. Date: Nov. 1, 2018

(54) CONTROL SYSTEM FOR COOKING

(71) Applicant: Meyer Intellectual Properties Ltd., Kowloon (HK)

(72) Inventors: Jonathan A. Jenkins, Seattle, WA (US); Brenden Duncombe-Smith, Seattle, WA (US)

(73) Assignee: Meyer Intellectual Properties Ltd., Kowloon (HK)

(21) Appl. No.: 15/964,529

(22) Filed: Apr. 27, 2018

Related U.S. Application Data
(60) Provisional application No. 62/491,045, filed on Apr. 27, 2017.

(51) Int. Cl. A47J 36/32; A47J 37/10; A47J 45/06

(52) U.S. Cl. CPC A47J 36/32; A47J 45/061; A47J 37/10

(57) ABSTRACT

According to one example, a system includes a cooking device operable to be used to cook a food item. The cooking device includes one or more motion sensors operable to detect a motion associated with the cooking device. The system further includes a wireless device operable to display a cooking recipe in a graphical user interface. The system also includes a one or more processors communicatively coupled to the one or more motion sensors. The processors are operable, when executed, to receive one or more indications of a detected motion associated with the cooking device, and further operable to determine a device instruction based on the one or more indications. The wireless device is further operable to perform the determined device instruction.

### CROSS-REFERENCE TO RELATED APPLICATIONS

This application claims priority to U.S. Provisional Patent Application No. 62/491,045 filed Apr. 27, 2017, the entirety of which is incorporated herein by reference.

### TECHNICAL FIELD

This disclosure relates generally to the field of cooking appliances and more specifically to a control system for cooking.

### BACKGROUND

Traditionally, a user has cooked food by manually turning on a heat source using a knob, placing the food over the heat source, and estimating (or measuring or timing) when the food is done cooking. Such traditional cooking techniques, however, may be deficient.

### SUMMARY

In a first example, a system comprises a heat source operable to provide an amount of energy to be used to cook a food item; a cooking device operable to be used to cook the food item, the cooking device comprising one or more motion sensors operable to detect a motion associated with the cooking device; and one or more processors communicatively coupled to the one or more motion sensors, and operable, when executed, to: receive one or more indications of a detected motion associated with the cooking device; and based on the one or more indications, determine a cooking instruction; wherein the heat source is further operable to modify the amount of energy provided by the heat source in accordance with the determined cooking instruction.

Another example includes any such system, wherein the one or more indications of a detected motion associated with the cooking device comprise: a first indication of a first detected motion; and a second indication of a second detected motion.

Another example includes any such system, wherein the one or more processors are further operable, when executed, to: determine whether the second indication was received within a predetermined amount of time after receipt of the first indication; and in response to the determination that the second indication was received within the predetermined amount of time, determine the cooking instruction based on the first indication and the second indication.

Another example includes any such system, wherein the cooking device is a cooking pot, a cooking pan, or a cooking utensil.

Another example includes any such system, wherein the cooking device further comprises the one or more processors.

Another example includes any such system, wherein the cooking device further comprises a display that is operable to provide a visual indication associated with the determined cooking instruction.

Another example includes any such system, wherein the motion associated with the cooking device is a tap by a user on a portion of the cooking device, a shake of the cooking device, a rotation of the cooking device, or a stop of movement of the cooking device.

Another example includes any such system, further comprising a heat source system that includes the heat source and the one or more processors.

In a second example, a method comprises detecting, by one or more motion sensors of a cooking device, one or more motions associated with the cooking device, wherein the cooking device is operable to be used to cook a food item; receiving, by one or more processors communicatively coupled to the one or more motion sensors, one or more indications of the detected motions associated with the cooking device; and based on the one or more indications, determining, by the one or more processors, a cooking instruction, wherein the determined cooking instruction is configured to cause a heat source to modify an amount of energy being provided by the heat source to cook the food item.

In a third example, a cooking device comprises a handle operable to be grasped by a user; one or more motion sensors operable to detect a motion associated with the cooking device; and one or more processors communicatively coupled to the one or more motion sensors, and operable, when executed, to: receive one or more indications of a detected motion associated with the cooking device; and based on the one or more indications, determine a cooking instruction, wherein the determined cooking instruction is configured to cause a heat source to modify an amount of energy provided by the heat source to cook a food item.

In a fourth example, a system comprises a cooking device operable to be used to cook a food item, the cooking device comprising one or more motion sensors operable to detect a motion associated with the cooking device; a wireless device operable to display a cooking recipe in a graphical user interface; and one or more processors communicatively coupled to the one or more motion sensors, and operable, when executed, to: receive one or more indications of a detected motion associated with the cooking device; and based on the one or more indications, determine a device instruction; wherein the wireless device is further operable to perform the determined device instruction.

Another example includes any such system, wherein the wireless device is further operable to change the displayed graphical user interface from a first portion of the cooking recipe to a second portion of the cooking recipe in accordance with the determined device instruction.

Another example includes any such system, wherein the one or more indications of a detected motion associated with the cooking device comprise: a first indication of a first detected motion; and a second indication of a second detected motion.

Another example includes any such system, wherein the one or more processors are further operable, when executed, to: determine whether the second indication was received within a predetermined amount of time after receipt of the first indication; and in response to the determination that the second indication was received within the predetermined amount of time, determine the cooking instruction based on the first indication and the second indication.

Another example includes any such system, wherein the cooking device is a cooking pot, a cooking pan, or a cooking utensil.

Another example includes any such system, wherein cooking device further comprises the one or more processors.

Another example includes any such system, wherein the motion associated with the cooking device is a tap by a user on a portion of the cooking device, a shake of the cooking device, a rotation of the cooking device, or a stop of movement of the cooking device.

Another example includes any such system, wherein the wireless device comprises the one or more processors.

Another example includes any such system, wherein the determined device instruction is an instruction move from a first portion of the cooking recipe to a second portion of the cooking recipe, an instruction to move from a second portion of the cooking recipe to a first portion of the cooking recipe, an instruction to display a different cooking recipe, an instruction to play a video associated with the cooking recipe, or an instruction to stop displaying the cooking recipe.

In a fifth example, a method comprises detecting, by one or more motion sensors of a cooking device, one or more motions associated with the cooking device, wherein the cooking device is operable to be used to cook a food item; receiving, by one or more processors communicatively coupled to the one or more motion sensors, one or more indications of the detected motions associated with the cooking device; and based on the one or more indications, determining, by the one or more processors, a device instruction, wherein the determined device instruction is configured to cause a wireless device to perform an action in accordance with the determined device instruction.

In a sixth example, a cooking device comprises a handle operable to be grasped by a user; one or more motion sensors operable to detect a motion associated with the cooking device; and one or more processors communicatively coupled to the one or more motion sensors, and operable, when executed, to: receive one or more indications of a detected motion associated with the cooking device; and based on the one or more indications, determine a device instruction, wherein the determined device instruction is configured to cause a wireless device to perform an action in accordance with the determined device instruction.

In a seventh example, a cooking control device comprises a handle for grasping by a user, one or more accelerometers disposed for detecting movement of the handle, a signal processor operative to receive an output of the one or more accelerometers and recognize one or more predetermined movement sequences as a command, a transmitter connected in signal communication with the signal processor for transmitting the command, and a power source for energizing the one or more accelerometers, the signal processor, and the transmitter.

Another example includes any such cooking control device, wherein the command transmitted by the transmitter is operative to modify one of a cooking parameter of an electronic cooking device.

Another example includes any such cooking control device, wherein the handle is disposed on a utensil so the cooking control device is integrated with the utensil.

### BRIEF DESCRIPTION OF THE FIGURES

For a more complete understanding of the present disclosure and its features and advantages, reference is now made to the following description, taken in conjunction with the accompanying drawings, in which:

FIGS. 1A-1B illustrate an example cooking system that may assist a user in cooking a food item;

FIGS. 2A-2B are example timing diagrams associated with the example cooking system of FIGS. 1A-1B; and

FIG. 3 illustrates another example cooking system that may assist a user in cooking a food item.

### DETAILED DESCRIPTION

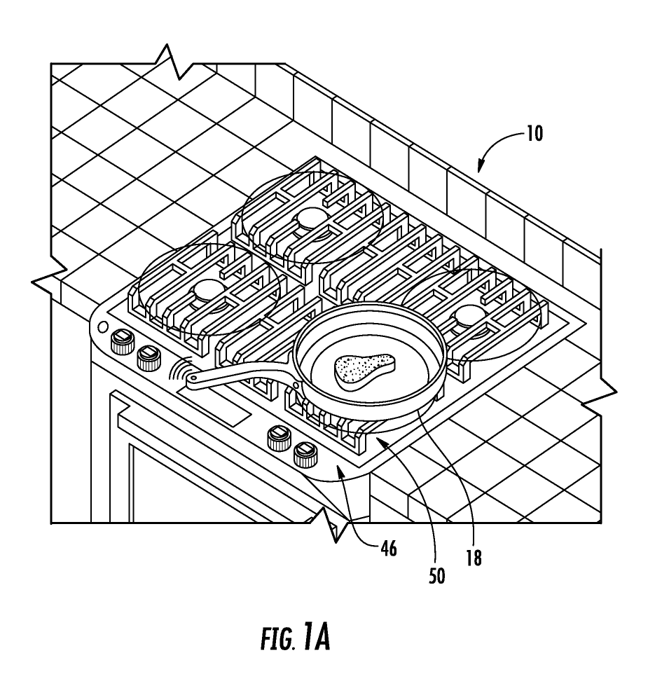

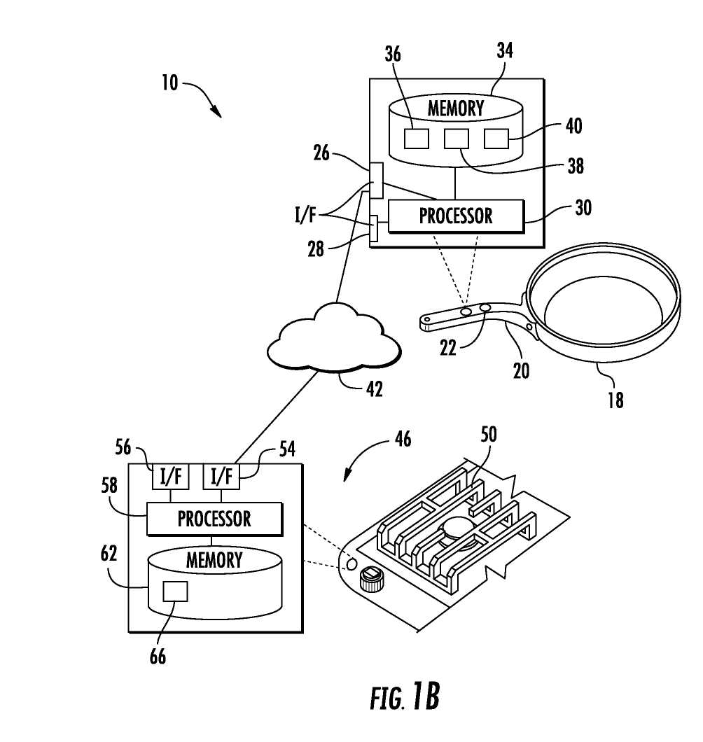

Embodiments of the present disclosure are best understood by referring to FIGS. 1A-3 of the drawings, like numerals being used for like and corresponding parts of the various drawings.

Traditionally, a user has cooked food by manually turning on a heat source using a knob, placing the food over the heat source, and estimating (or measuring or timing) when the food is done cooking. Such traditional cooking techniques, however, may be deficient. For example, when a user is cooking a food item, their hands may be full (e.g., they may be holding the food item, or a cooking pan, or a cooking utensil, or a combination of the preceding). This may prevent the user from easily adjusting the amount of heat being used to cook the food. Also, the user's hand may be soiled (e.g., with food), which may make touching a cooking dial undesirable. In some examples, the cooking system of FIGS. 1-3 may address one or more of the above deficiencies.

FIGS. 1A-1B illustrate an example cooking system 10 that may assist a user in cooking a food item (such as a steak). As is illustrated, the cooking system 10 includes a cooking device 18 (e.g., a cooking pan) that has one or more motion sensors 22 that may detect a motion associated with the cooking device 18 (e.g., a rotation of the cooking device 18). The cooking system 10 further includes a heat source system 46 (e.g., a gas burner system, an electric burner system, or an induction burner system) that includes a heat source 50 (e.g., the front left gas burner of a stove top). The heat source 50 may provide an amount of energy (e.g., heat) that may be used to cook the food item.

The cooking system 10 of FIGS. 1A-1B may allow a user to utilize the cooking device 18 to change one or more parameters associated with cooking. For example, the cooking system 10 may allow the user to utilize the cooking device 18 to increase the amount of energy provided by the heat source 50, or decrease the amount of energy provided by the heat source 50. To do so, the user may perform one or more motions associated with the cooking device 18. For example, the user may tap on a portion of the cooking device 18 (e.g., tap on the handle of the cooking pan). The motion sensors 22 may sense (or otherwise detect) these motions, and a processor 30 of cooking device 18 may determine that these motions are an instruction from the user (e.g., an instruction to increase the amount of energy provided by the heat source 50). Based on the determination, the processor 30 may send a cooking instruction 38 to the heat source system 46, causing the heat source 50 to perform the cooking instruction 38 (e.g., increasing the amount of energy provided by the heat source 50).

The cooking system 10 may allow the cooking device 18 to replace or supplement a conventional control panel (e.g., switches, knobs, buttons, etc.) on a heat source system 46, in some examples. As a result, the user may be able to control a heat source system 46 (and heat source 50) without having to touch the heat source system 46 (and heat source 50). This may prevent the user from having to let go of the cooking device 18 while cooking. Also, it may prevent the user from having to touch the heat source system 46 with soiled hands from cooking. As such, the heat source system 46 may stay cleaner. Furthermore, it may also provide a safer cooking environment, as it may prevent accidental engagement of the controls of the heat source system 46 (e.g., accidentally bumping the burner dial to high-heat).

In some examples, the cooking system 10 may allow the heat source system 46 to not include a control panel (or other control system), as the heat source system 46 can be controlled entirely with the cooking device 18. This may free up space in the heat source system 46 for other purposes, and/or may allow the size of the heat source system 46 to be decreased.

As is illustrated, the cooking system 10 includes a cooking device 18 that may have one or more motion sensors 22, a network interface 26, a processor 30, and a memory unit 34. The cooking device 18 may be any device that may be used in cooking a food item. For example, the cooking device 18 may be a food support platform that may support, hold, and/or enclose the food item while it is being cooked, such as a pot, a pan, a skillet, a vessel (e.g., a vessel having a handle), a tray, a grill platen, a grate, an oven, a pressure cooker, a rice cooker, a slow cooker, a microwave oven, a toaster oven, an oven, a teapot, any other device that may support, hold, and/or enclose a food item while it is being cooked, or any combination of the preceding. As is illustrated, the cooking device 18 is a cooking pan.

As another example, the cooking device 18 may be a cooking utensil, such as a fork, a spoon, a knife, a ladle, tongs, a spatula, a measurement or thermal probe (e.g., a probe that measures temperature), any other utensil that may be used while cooking a food item, or any combination of the preceding. In such examples, the cooking device 18 (e.g., a cooking utensil) may be a separate device that may be introduced into a food support platform (such as into a cooking pot).

The cooking device 18 may have one or more handle(s) 20 that may be grasped by a user when the user is touching, holding, and/or moving the cooking device 18. The handle 20 may have a working distal end to which is attached a working tool (e.g., the portion of the cooking device 18 that forms the pot, pan, etc.). The nature of the working tool at the distal end may distinguish a food support platform (e.g., a pan, a pot, a skillet, a vessel, etc.) from a utensil (e.g., a fork, a spoon, a knife, a ladle, tongs, a spatula, etc.). The handle 20 may have any shape and/or size. Furthermore, the handle 20 may be made of any material.

A motion sensor 22 represents any sensor that may sense a motion associated with the cooking device 18. For example, the motion sensor 22 may be an accelerometer. The motion sensor 22 may be a two-dimensional motion sensor, or a three-dimensional motion sensor. The motion sensor 22 may sense motion in any direction and/or may sense a rotation (or other movement) about any coordinate axis. In addition to sensing a motion, the motion sensor 22 may transmit an indication of the sensed motion to the processor 30. For example, if the motion sensor 22 senses a tap on the handle of the cooking device 18, the motion sensor may transmit an indication of that tap to the processor 30. The indication of the sensed motion may be any information that identifies (or allows the processor 30 to identify) the sensed motion.

The cooking device 18 may include any number of motion sensors 22. For example, the cooking device 18 may include one motion sensor 22, two motion sensors 22, three motion sensors 22, or any other number of motion sensors 22. In some examples, it may be preferable for the cooking device 18 to include multiple motion sensors 22, so as to assist in sensing motion in any direction and sensing rotation (or other movement) about any coordinate axis.

Each motion sensor 22 may sense a different type of motion. For example, a first motion sensor 22 may sense an up-and-down movement while the second motion sensor 22 may sense a left and right movement. Alternatively, one or more motion sensors 22 may sense the same type of motion. This may allow the detected motion of a first motion sensor 22 to be compared to a detected motion of a second motion sensor 22, so as to determine whether one of the motion sensors 22 falsely detected motion.

The motion sensors(s) 22 may be positioned at (and coupled at) any location in or on the cooking device 18 so as to allow the motion sensor(s) 22 to sense motion, and to further allow the motion sensor(s) 22 to transmit such information to the processor 30. As an example, the motion sensor(s) 22 may be coupled to a base of cooking device 18. As another example, the motion sensor(s) 22 may be coupled to the handle 20 (in the interior and/or on the exterior) of the cooking device 18.

As is discussed above, the cooking device 18 may further include one or more network interfaces 26, one or more processors 30, and one or more memory units 34. The network interface 26, processor 30, and memory unit 34 may be positioned at (and coupled at) any location on or in the cooking device 18 so as to allow the network interface 26 and processor 30 to communicate with the motion sensor(s) 22, and further communicate with other elements of the system 10, such as the heat source system 46. According to the illustrated example, the network interface 26, processor 30, and memory unit 34 are positioned in (or on) the handle 20 of the cooking device 18. Such a positioning may, in some examples, protect these components from excessive heat. As a further example, one or more of the network interface 26, processor 30, and/or memory unit 34 may be integrated with the motion sensor(s) 22. In such examples, the motion sensor(s) 22 may be able to communicate directly (via a wireless or wired link) with other elements of the system 10, such as the heat source system 46.

In examples where the cooking device 18 includes more than one handle 20, the motion sensors 22, network interface 26, processor 30, and/or memory unit 34 may be distributed between two or more of the handles 20, but remaining in power and signal communication. Alternatively, none of the elements may be positioned on or in the handles 20. Instead, they may be positioned on or in other locations of the cooking device 18.

Although described as being included on or in the cooking device 18, the motion sensors 22, network interface 26, processor 30, and/or memory unit 34 may be removable from the cooking device 18 (e.g., removable from the handle 20 of the cooking device 18). This may allow one or more of these elements to be removed from a current cooking device 18 and subsequently coupled to a different cooking device 18. Thus, one set of motion sensors 22, network interface 26, processor 30, and/or memory unit 34 may be re-useable on multiple cooking devices 18.

Furthermore, when the handle 20 includes the motion sensors 22, network interface 26, processor 30, and/or memory unit 34, the entire handle 20 (including all of its elements) may be removed from the cooking device 18. This may allow the handle 20 (and all of its elements) to be removed from a current cooking device 18 and subsequently coupled to a different cooking device 18. Thus, a single handle 20 may be re-useable on (and interchangeable with) multiple cooking devices 18. As an example, a handle 20 may originally be coupled to a pot, but may be removed and coupled to a pan. As another example, a handle 20 may originally be coupled to a spatula, but may be removed and coupled to a knife, or even a pan.

Network interface 26 represents any suitable device operable to receive information from network 42, transmit information through network 42, receive information from motion sensors 22, transmit information to motion sensors 22, perform processing of information, communicate to other devices, or any combination of the preceding. For example, network interface 26 receives indications of a detected motion from motion sensors 22. As another example, network interface 26 transmits cooking instructions 38 (e.g., increase temperature, decrease temperature, etc.) to heat source system 46. Network interface 26 represents any port or connection, real or virtual, (including any suitable hardware and/or software, including protocol conversion and data processing capabilities, to communicate through a local area network (LAN), a metropolitan area network (MAN), a wide area network (WAN), or other communication system) that allows cooking device 18 to exchange information with network 42, heat source system 46, or other components of system 10. In some examples, the network interface 26 may be a transmitter, a receiver, and/or a transceiver. In such examples, the network interface 26 may transmit and/or receive information via a wired connection or a wireless connection.

Processor 30 communicatively couples to network interface 26 and memory unit 34, and controls the operation and administration of cooking device 18 by processing information received from network interface 26, memory unit 34, and motion sensor(s) 22. Processor 30 includes any hardware and/or software that operates to control and process information. For example, processor 30 executes a cooking device management application 36 to control the operation of cooking device 18, such as to communicate with the motion sensor(s) 22 and the heat source system 46 to assist in controlling a temperature at which a food item is cooked. In operation, the processor 30 may receive an indication of a sensed motion from the motion sensor(s) 22. Based on this indication, the processor may utilize motion list 40 to determine a cooking instruction 38 to be performed by the heat source 50. Furthermore, the processor 30 may transmit the cooking instruction 38 to the heat source system 46. Processor 30 may be a programmable logic device, a digital signal processor (DSP), a microcontroller, a microprocessor, a programmable logic controller (PLC), a controller, a logic circuit, an analog controller, any other processing device or the like, or any combination of the preceding.

Memory unit 34 stores, either permanently or temporarily, data, operational software, or other information for processor 30. Memory unit 34 includes any one or a combination of volatile or non-volatile local or remote devices suitable for storing information. For example, memory unit 34 may include random-access memory (RAM), read-only memory (ROM), magnetic storage devices, optical storage devices, any other suitable information storage device, or any combination of the preceding. While illustrated as including particular information modules, memory unit 34 may include any suitable information for use in the operation of cooking device 18.

As illustrated, memory unit 34 includes cooking device management application 36, cooking instructions 38, and motion list 40. Cooking device management application 36 represents any suitable set of instructions, logic, or code embodied in a computer-readable storage medium and operable to facilitate the operation of cooking device 18.

Cooking instructions 38 represent any set of instruction(s) that may be utilized to assist the user in cooking. For example, the cooking instructions 38 may be a temperature that a food item is to be cooked at (such as 375° Fahrenheit), an instruction to increase an amount of energy being provided by the heat source 50 (e.g., energize), an instruction to decrease the amount of energy being provided by the heat source 50 (e.g., de-energize), an instruction to turn the heat source 50 off (or on), a selection of a mode setting, a selection of a power level of the heat source 50, an instruction to initiate and/or acknowledge a wireless signal that pairs the cooking device 18 to the heat source system 46 or to another element of system 10, any other instruction(s) that may be utilized by the heat source system 46 to assist the user in cooking, or any combination of the preceding.

Motion list 40 represents any listing of motion(s) that may be utilized by the processor 30 to determine which cooking instruction 38 has been requested by a user. Each of the motion listed in the motion list 40 may be associated with a particular cooking instruction 38. As an example, a first motion (e.g., a tap on the handle of the cooking device 18) may be associated with a first cooking instruction 38 (e.g., increase the amount of energy being provided by the heat source 50), and a second motion (e.g., shake the cooking device 18) may be associated with a second cooking instruction 38 (e.g., decrease the amount of energy being provided by the heat source 50). The motion list 40 may include any type of motion for association with a cooking instruction 38. Examples of motions include a tap by a user on a portion of the cooking device 18 (e.g., a tap on the handle of the cooking device 18), a tap of the cooking device 18 on a surface (e.g., a tap of the bottom of the cooking device 18 or the handle of the cooking device 18 on a table or the heat source 50), a shake of the cooking device 18, a rotation of the cooking device 18 (e.g., a clockwise or counterclockwise rotation), a stop of movement of the cooking device 18 (e.g., a stop in a stirring motion made using a cooking device 18, such as a whisk), a movement of the cooking device 18 in a particular direction (e.g., up, down, left, right, diagonal), any other motion, or any combination of the preceding.

The rotation of the cooking device 18 may be rotation in any plane. For example, the rotation may be in the horizontal plane as the base of the cooking device 18 is resting on the heat source 50 (or other surface). Such horizontal rotation of the cooking device 18 (and/or the handle 20 of the cooking device 18) may be preferred because the bottom of the cooking device 18 may be in contact with heat source 50 (or other surface), thereby precluding accidental movement of the cooking device 18 out of the horizontal plane, in some examples.

The motion list 40 may include a direction of movement. For example, a first direction of rotation of the cooking device 18 (e.g., clockwise) may be associated with a first cooking instruction 38 (e.g., increase the amount of energy provided by the heat source 50), and a second direction of rotation of the cooking device 18 (e.g., counterclockwise) may be associated with a second cooking instruction 38 (e.g., decrease the amount of energy provided by the heat source 50).

The motion list 40 may include a magnitude of movement. For example, a magnitude of rotation of the cooking device 18 (e.g., clockwise by 45 degrees) may be associated with a particular cooking instruction 38 (e.g., increase the amount of energy provided by the heat source 50). As another example, the magnitude of rotation of the cooking device 18 (e.g., clockwise by 45 degrees) may be associated with a value for a particular cooking instruction 38 (e.g., increase the amount of energy provided by the heat source 50 by 10 degrees). As the magnitude of movement is increased (or decreased), the value for the particular cooking instruction 38 may be increased (or decreased).

The motion list 40 may include a repetition of movement. For example, a repeated movement may be associated with an increase (or decrease) of a value for a particular cooking instruction 38. In such an example, repeating the movement may incrementally increase (or decrease) the amount of energy provided by the heat source 50 by 10 degrees or 20 degrees, for example. The motion list 40 may also include a continuation of movement. For example, a continuation of movement may be associated with an increase (or decrease) of a value for a particular cooking instruction 38. In such an example, continuously rotating the cooking device 18 may continuously increase (or decrease) a value for a particular cooking instruction 38. In such an example, a rotation of the cooking device 18 may be similar to rotating a temperature dial (or other control knob) of the heat source system 46, for example. The more the cooking device 18 is rotated, the more the cooking temperature may increase (or vice versa).

The motion list 40 may also include one or more movements that may turn on (or off) the cooking device 18's processing of cooking instructions 38. For example, if the cooking device 18 is not turned on, the processor 30 may not determine any cooking instructions 38. This may allow the user to utilize the cooking device 18 in any manner, without accidentally requesting a particular cooking instruction 38. In such an example, the user may turn on the cooking device 18, thereby allowing the user to subsequently request one or more cooking instructions 38. Any type of motion(s) may cause the cooking device 18 to turn on. For example, the cooking device 18 may be turned on by the user tapping on the handle of the cooking device 18 once (or any other number of times).

Any number of motions may be associated with a particular cooking instruction 38. For example, a single motion may be associated with a particular cooking instruction 38. In such an example, performance of a single motion may cause the cooking instruction 38 to be determined and performed. As another example, multiple motions may be associated with a particular cooking instruction 38. In such an example, performance of each of these multiple motions may cause the cooking instruction 38 to be determined and performed.

The multiple motions associated with a particular cooking instruction 38 may be a sequence (or other series) of motions. For example, a sequence of two taps on the handle 20 of the cooking device 18 within a time period of 2 seconds may be associated with a particular cooking instruction 38 (e.g., decrease the amount of energy being provided by the heat source 50). In such an example, if the user taps on the handle 20 of cooking device 18 twice within 2 seconds, the amount of energy provided by the heat source 50 may be decreased. Alternatively, if the user taps on the handle 20 of the cooking device 18 three times within 2 seconds (or two times within 3 seconds), the motions may not be determined to be associated with the cooking instruction 38 and the amount of energy provided by the heat source 50 may not be decreased. By associating a sequence of motions with a particular cooking instruction 38, the system 10 may avoid false inputs.

The sequence of motions associated with a cooking instruction 38 may be any sequence of two or more motions. The sequence may be a complex sequence not expected in normal use of the cooking device 18, but sufficiently simple for a user to remember and execute quickly. Such types of motions may include taps, rotations of the cooking device 18, or any other motion not expected in normal use of the cooking device 18. The sequence may include time periods for motions. For example, the sequence may include a time period within which the sequence of motions must be completed (e.g., two seconds), a time period that must elapse between two successive motions (e.g., a first motion followed by a one second period with no motion, followed by a second motion), any other time period for motions, or any combination of the preceding.

The sequence may be a first set of one or more motions that identify a type of cooking instruction 38, and a second set of one or more motions that identify a value associated with the cooking instruction 38. For example, the sequence may be one or more taps on the handle that identify the cooking instruction 38 (e.g., an instruction to change the cooking temperature), followed by a rotation of the cooking device 18 that identifies the value (e.g., where a clockwise rotation is associated with an instruction to increase temperature, and where a counterclockwise rotation is associated with an instruction to decrease temperature).

The motions included in the motion list 40, the instructions included in the cooking instructions 38, and/or the association between particular motion(s) and a particular instruction may be predetermined by a manufacturer and/or a user. For example, the motions and instructions (and their associations) may be set-up by the manufacturer of the cooking device 18 and/or the heat source system 46. This may allow the manufacture to determine which motions cause which instructions to be performed. As another example, a user may set-up one or more (or all) of the motions, instructions, and their associations. This may allow the user to customize which motions cause which instructions to be performed.

As is illustrated in FIG. 1B, the cooking device 18 further includes a user interface system 28. The user interface system 28 represents any suitable components that allow the cooking device 18 to provide output (such as a visual output) to the user of cooking device 18. For example, the user interface system 28 may be a display that provides a visual indication that one or motions have been sensed and/or that one or more cooking instructions 38 have been transmitted to the heat source system 46 in response to the detected motions. Such an indication may include a representation of the particular cooking instruction 38. For example, if the cooking instruction 38 is an instruction to increase the amount of heat by 50°, the indication provided by the user interface system 28 may be a graphical representation of that particular instruction (e.g., a graphical representation of “increase the amount of energy by 50°”). The display may further provide a visual indication that the cooking instructions 38 have been received by the heat source system 46 and/or are being performed (e.g., feedback from the heat source system 46).

The user interface system 28 may provide visual output (e.g., with graphical representations, lights, and/or colors), auditory output (e.g., using one or more speakers or other sound generators), tactile output (e.g., from vibrators in the handle), any other type of output, or any combination of the preceding. The user interface system 28 may be positioned at any location on or in the cooking device 18. As one example, it may be positioned on or in the handle of the cooking device 18. The user interface system 28 may be powered by a power source (discussed below). Furthermore, it may provide output to the user in response to signals from the processor 30.

The cooking device 18 may further include a power source (not illustrated) that provides power (or energy) to the components of the cooking device 18, allowing them to operate. The power source may be any type of power source, such as an electrical power source (e.g., a battery). As examples, the cooking device 18 may have a wired connection to an external power source (e.g., an electrical outlet), an external battery, a stepped down line source (via a transformer) or a thermo-electric power generator.

Network 42 represents any suitable network operable to facilitate communication between the components of system 10, such as cooking device 18 and heat source system 46. Network 42 may include any interconnecting system capable of transmitting audio, video, signals, data, messages, or any combination of the preceding. Network 42 may include all or a portion of a public switched telephone network (PSTN), a public or private data network, a LAN, a MAN, a WAN, a wireless personal area network (WPAN), a local, regional, or global communication or computer network (such as the Internet), a wireline or wireless network, an enterprise intranet, or any other suitable communication link, including combinations thereof, operable to facilitate communication between the components. Preferable examples of network 42 may include a WPAN (which may include, for example, Bluetooth, Bluetooth low power, Bluetooth 5, ANT+, Zigbee (IEEE 802.15.4), other IEEE 802.15 protocols, IEEE 802.11 A, B or G without limitation, and Wi-FI (IEEE 802.11)), a cellular communication network, an infrared communication network, any other wireless network operable to facilitate communication between the components, or any combination of the preceding.

Heat source system 46 represents any suitable components that can provide an amount of energy to cook a food item, and that can further communicate with the cooking device 18 to assist the user in cooking a food item.

As is illustrated, the heat source system 46 includes a heat source 50, a network interface 54, a user interface system 56, a processor 58, and a memory unit 62. The heat source 50 may be any device that may provide an amount of energy to cook a food item. For example, the heat source 50 may be a burner (such as an induction burner, gas burner, infrared burner, and/or heating coil), a resistive heating element, a heat lamp (such as Halogen lamp), an oven, a microwave, a stove top, a range (e.g., a gas range top), a grill, a griddle, a toaster, coffee or tea maker, any other device that may provide an amount of energy to cook a food item, or any combination of the preceding. As is illustrated, the heat source 50 is a gas burner that provides heat energy in the form of a gas flame. The heat source system 46 may include any number of heat sources 50.

The heat source 50 may further be connected to a power source that provides power (or energy) to the heat source 50, thereby allowing the heat source 50 to provide an amount of energy to cook a food item. The power source may be any type of power source, such as an electrical power source (e.g., a battery or a connection to an electrical outlet), a gas power source (e.g., a gas canister or a connection to a gas line), any other source of power (or energy), or any combination of the preceding.

As is discussed above, the heat source system 46 may further include one or more network interfaces 54, one or more user interface systems 56, one or more processors 58, and one or more memory units 62. The network interface 54, user interface system 56, processor 58, and memory unit 62 may be positioned at any location on, in, or adjacent the heat source system 46 so as to allow the network interface 54 and processor 58 to communicate with the heat source(s) 50 of the heat source system 46 and/or communicate with the cooking device 18. In such an example, the processor 58 may be communicatively coupled (and potentially physically or electrically coupled) to the heat source(s) 50 and/or the cooking device 18.

Network interface 54 represents any suitable device operable to receive information from network 42, transmit information through network 42, receive information from heat source 50, transmit information to heat source 50, perform processing of information, communicate with other devices, or any combination of the preceding. For example, network interface 54 receives cooking instructions 38 from the cooking device 18, and further communicates with the heat source 50 to cause the heat source 50 to perform the cooking instructions 38. Network interface 18 represents any port or connection, real or virtual, (including any suitable hardware and/or software, including protocol conversion and data processing capabilities, to communicate through a LAN, a MAN, a WAN, or other communication system) that allows heat source system 46 to exchange information with network 42, cooking device 18, heat source 50, and/or other components of system 10.

User interface system 56 represents any suitable components that allow a user to provide input to the heat source system 46 and/or that allow the heat source system 46 to provide output (such as a visual output) to the user of heat source system 46. For example, the user interface system 56 may include an input device (e.g., a rotary dial, a touch screen, etc.) that allows the user to input a desired amount of energy that is to be used by the heat source system 46 to cook a food item. As another example, the user interface system 56 may provide a visual representation of the amount of energy that is currently being used by the heat source system 46 to cook a food item. As another example, the user interface system 56 may provide an indication (e.g., a visual indication, an audible indication, etc.) that it has received cooking instructions 38 from the cooking device 18 and that it will begin performing (and/or is done performing) the received cooking instructions 38. Such an indication may include a representation of the particular cooking instruction 38. For example, if the cooking instruction 38 is to increase the amount of energy being provided by the heat source 50, the indication provided by the user interface system 56 may indicate that it is increasing the amount of energy (e.g., increasing the amount of energy by 50°).

Processor 58 communicatively couples to network interface 54, user interface system 56, and memory unit 62, and controls the operation and administration of heat source system 46 by processing information received from network interface 54, user interface system 56, and memory unit 62. Processor 58 includes any hardware and/or software that operates to control and process information. For example, processor 58 executes a heat source system management application 66 to control the operation of heat source system 46, such as to provide an amount of energy to cook a food item, and to communicate with the cooking device 18 to assist the user in cooking. Processor 58 may be a programmable logic device, a DSP, a microcontroller, a microprocessor, a PLC, a controller, a logic circuit, an analog controller, any other processing device or the like, or any combination of the preceding.

Memory unit 62 stores, either permanently or temporarily, data, operational software, or other information for processor 58. Memory unit 62 includes any one or a combination of volatile or non-volatile local or remote devices suitable for storing information. For example, memory unit 62 may include RAM, ROM, magnetic storage devices, optical storage devices, any other suitable information storage device, or any combination of the preceding. While illustrated as including particular information modules, memory unit 62 may include any suitable information for use in the operation of heat source system 46.

As illustrated, memory unit 62 includes heat source system management application 66. Heat source system management application 66 represents any suitable set of instructions, logic, or code embodied in a computer-readable storage medium and operable to facilitate the operation of heat source system 46.

Modifications, additions, and/or substitutions may be made to the cooking system 10, the components of the cooking system 10, and/or the functions of the cooking system 10 without departing from the scope of the specification. For example, the cooking system 10 may further include one or more remote devices (or intermediary devices) that may perform one or more of the functions of the cooking system 10. As an example of this, the cooking system 10 may include a wireless device (such as a Smartphone or tablet computer), another computing device (such as a web server), or a controller that is built into another cooking appliance (and that can control other devices). In such an example, the wireless device may operate as an intermediary, by receiving the cooking instructions 38 sent by the cooking device 18 and re-transmitting them to the heat source system 46 and/or heat source 50, causing the heat source 50 to perform the cooking instructions 38. In such examples, the intermediary device may communicate with the cooking device 18 using a first protocol, and may also communicate with the heat source system 46 and/or heat source 50 using a second protocol. The second protocol may be the same as the first protocol (e.g., both are Bluetooth) or the second protocol may be different than the first protocol (e.g., the first protocol may be near field communications (NFC) while the second protocol may be Bluetooth).

As another example, the motion sensor(s) 22 may further be used to save power in the cooking device 18. In such an example, if the motion sensor(s) 22 detect a lack of motion associated with the cooking device 18, the processor 30 may be placed in a sleep or standby mode. Additionally, the processor 30 may also send advertisement packets less frequently (such as only when movement is detected again).

As one example of operation of FIGS. 1A-1B, a user may desire to cook a food item, such as a steak. When cooking the food item, the user may desire to change a parameter associated with the cooking. For example, the user may desire to increase the amount of energy provided by the heat source 50, or decrease the amount of energy provided by the heat source 50. Unfortunately, the user may be unable to change the parameter manually, or may not desire to change the parameter manually (e.g., the user's hands may be dirty or may be full from holding cooking devices). Instead, the user may perform one or more motions associated with the cooking device 18. For example, the user may tap on a portion of the cooking device 18 (e.g., tap on the handle of the cooking pan).

The motion(s) performed by the user may be any type of motion. Furthermore, the motion(s) may be a sequence of motions. For example, the motion(s) may be a first motion (e.g., a tap on the handle of the cooking pan) followed by a second motion (e.g., a rotation of the cooking pan). The motion(s) may be a set of one or more motions that represent a cooking instruction 38 that is to be performed as a result of the motion(s). Thus, the user may perform a particular set of motion(s) in order to cause a particular cooking instruction 38 to be performed.

As a result of performing the one or more motions, the motion sensor(s) 22 of the cooking device 18 may sense (or otherwise detect) the performed motions. For example, if the user taps on the handle of the cooking device 18, the motion sensors(s) 22 may detect the tap. The motion sensor(s) 22 may then transmit an indication of the detected motion to the processor 30. The indication of a detected motion may be any data (or other information) that may allow the processor 30 to determine the motion performed by the user. For example, the indication may be data that expressly identifies the detected motion (e.g., data that expressly identifies a tap on the handle) or may be a signal or pointer (or any other type of data) that may be used by the processor 30 to determine that the user tapped on the handle (e.g., a pointer that causes the processor 30 to look up stored data in order to determine that the user tapped on the handle). In some examples, the motion sensor(s) 22 may convert the detected motion (or motions) into an electronic format or signature. This electronic format or signature may be the indication.

Following transmittal of the indication of the detected motion, the processor 30 may receive the indication and may determine the cooking instruction 38 based on the indication. The processor 30 may determine the cooking instruction 38 in any manner based on the indication. For example, the processor 30 may compare the received indication to the motion list 40 to determine a match. If the received indication (e.g., a tap on the handle) matches a particular stored motion (e.g., a tap on the handle), the motion list 40 may further identify the cooking instruction 38 to be performed (e.g., increase the amount of power). The motion list 40 may identify the cooking instruction 38 in any manner. For example, the motion list 40 may list the particular cooking instruction 38 in association with the particular motion(s) (e.g., a relational list or a relational database). As other examples, for each motion (or set of motions), the list may include a signal or pointer (or any other type of data) that may be used by the processor 30 to determine the cooking instruction 38 (e.g., it may include a pointer to a cooking instruction 38 included in a separate list or data set).

The processor 30 may determine the cooking instruction 38 using any number of indications received from the motion sensor(s) 22. For example, as is discussed above, a sequence of motions may be associated with a particular cooking instruction 38. In such an example, the processor 30 may receive each of these indications (e.g., an indication of a first detected motion, an indication of a second detected motion, etc.). The processor 30 may then determine the cooking instruction 38 in any manner based on the indications. For example, the processor 30 may compare the received indications to the motion list 40 to determine a match. If the received indications match (e.g., a tap on the handle, followed by a rotation of the cooking device, followed by a second tap on the handle) a particular stored motion (e.g., a tap on the handle, followed by a clockwise rotation of the cooking device, followed by a second tap on the handle), the motion list 40 may identify the cooking instruction 38 to be performed (e.g., increase the amount of power).

As is discussed above, the motions performed by the user may have a direction of movement, a magnitude of movement, a repetition of movement, or any other characteristic of movement. Furthermore, a sequence of motions performed by the user may have a time period for the motions. The processor 30 may determine the cooking instruction 38 using indications of a detected motion having one or more of these characteristics. For example, a particular cooking instruction 38 may be associated with a sequence of motions that requires a first motion (e.g., a tap of the handle) to be followed by a second motion (e.g., a rotation of the cooking device) within a time period from the first motion (e.g., within two seconds of the tap of the handle). In such an example, the processor 30 may determine whether the received indications and the time frame of the received indications matches the stored motions and stored time frame. As an example, using the motion list 70, the processor 30 may determine whether it received an indication of first motion (e.g., an indication of a tap of the handle 20) followed by an indication of a second motion (e.g., a rotation of the cooking device 18), and may further determine whether the indication of the second motion was received within the time period (e.g., within two seconds) of the receipt of the indication of the first motion. If so, the processor 30 may determine the particular cooking instruction 38 associated with those motions. If not, the processor 30 may determine a different cooking instruction 38, or no cooking instruction 38 at all.

In some examples, a detected motion may not be a motion associated with a cooking instruction 38. For example, the motion sensor(s) 22 may detect and send an indication of a user moving the cooking device 18 upward. If such an upward motion is not included in the motion list 40 (or if the indication is otherwise determined to not be associated with a cooking instruction 38), the processor 30 may determine that this is a false detected motion. As such, the processor 30 may not determine a cooking instruction 38 for that indication.

Following the determination of a cooking instruction 38, the user interface system 28 of the cooking device 18 may provide an output to the user. The output may be any type of output that may provide information to the user. As an example, the output may indicate that the user's motion(s) have been detected, that a particular cooking instruction 38 has been determined, that the particular cooking instruction 38 has been transmitted for performance, or any other indication associated with system 10. The output may be provided in any manner and may be provided by any type of user interface system 28. As one example, the user interface system 28 may be a display that provides a visual indication of the determined cooking instruction 38. For example, if the processor 30 determines that the cooking instruction 38 is an instruction to increase the amount of energy, the display may provide a visual indication of this instruction, such as the text “increase energy” or a graphical “up” arrow.

Also following the determination of a cooking instruction 38, the processor 30 may transmit the cooking instruction 38 for performance. The cooking instruction 38 may be transmitted to any element of system 10 to cause the cooking instruction 38 to be performed. For example, the cooking instruction 38 may be transmitted directly to the heat source 50, so as to cause the heat source 50 to perform the cooking instruction 38 (e.g., modify the amount of energy being provided by the heat source 50). As another example, the cooking instruction 38 may be transmitted directly to the heat source system 46, and the heat source system 46 may cause the heat source 50 to perform the cooking instruction 38. As a further example, the cooking instruction 38 may be transmitted (directly or indirectly) to an intermediary device (e.g., a wireless device communicatively connected to cooking device 18), which may re-transmit the cooking instruction 38 to the heat source system 46 and/or the heat source 50.

The cooking instruction 38 may be performed in accordance with the cooking instruction 38. For example, if the cooking instruction 38 is to turn off the heat source 50, the heat source 50 may be turned off. As another example, if the cooking instruction 38 is to increase the temperature by 10°, the temperature may be increased by 10°.

Any number of cooking instructions 38 may be performed using the system 10 of FIGS. 1A-1B. For example, an entire cooking procedure may be performed (e.g., an entire meal may be cooked) using only the motions associated with the cooking device 18. In such an example, the heat source 50 may be turned on, a temperature selected, a temperature adjusted, and the heat source 50 may be turned off, all without the user having to touch the user interface 56 of the heat source system 46.

Modifications, additions, or omissions may be made to the example discussed above. For example, the user interface system 28 (e.g., display) of the cooking device 18 may not provide any output to the user. Instead, the output may be provided by the user interface system 56 of the heat source system 46, or it may not be provided at all. Furthermore, although the cooking device 18 is described above as transmitting cooking instructions 38 to the heat source system 46, in further examples the cooking device 18 may also measure the temperature associated with the food item (e.g., using one or more temperature sensors) and may send indications of the measured temperature to the heat source system 46, as is further described in U.S. Patent Application Publication No. 2017/0238749, filed Feb. 17, 2017, and entitled “User Interface for a Cooking System” (the entirety of which is incorporated herein by reference). Additionally, the cooking device 18 may also send identifying information to the heat source system 46, as is also further described in U.S. Patent Application Publication No. 2017/0238749. As another example, the steps of the example of operation may be performed in parallel or in any suitable order.

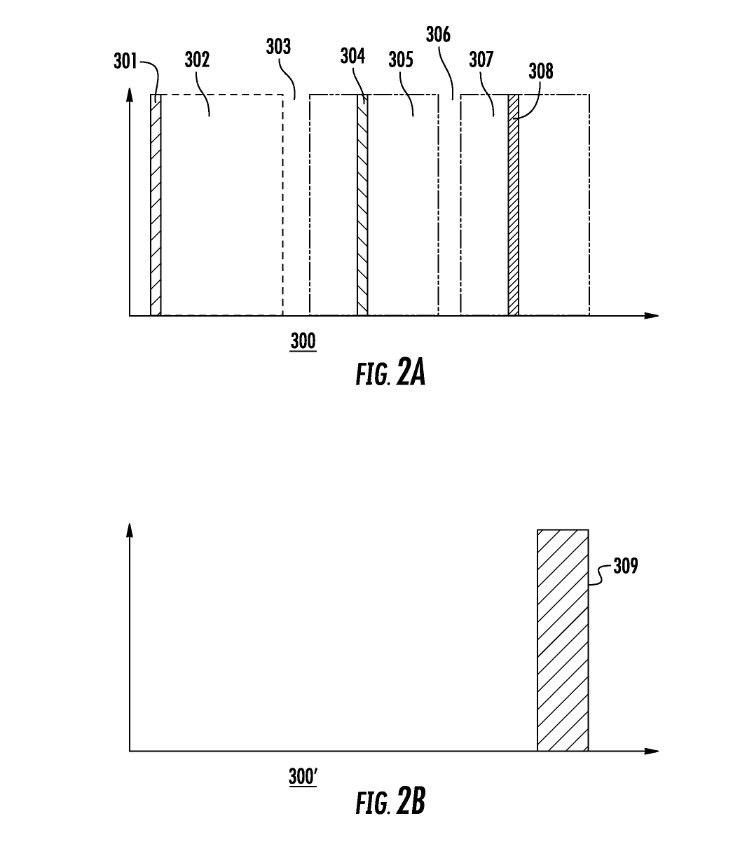

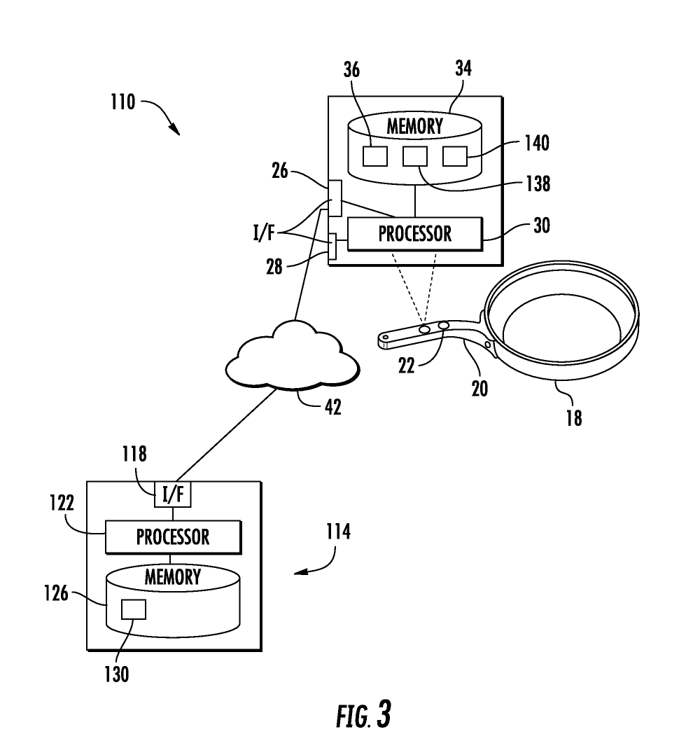

FIGS. 2A-2B are example timing diagrams associated with the cooking system 10 of FIGS. 1A-1B. FIG. 2A illustrates a timing diagram 300 for the processor 30 as it receives indications of detected motions, and FIG. 2B illustrates the timing diagram 300′ for the processor 30 as is transmits cooking instructions 38. The timing diagrams 300 and 300′ are based on a user providing a sequence of motions that will cause the heat source system 46 (or heat source 50) to perform a particular cooking instruction 38. For example, the timing diagrams 300 and 300′ are based on user providing a sequence of three motions that will cause the heat source system 46 to increase the amount of energy being provided by the heat source 50.

In FIG. 2A, a first movement of the user (e.g., a movement of the handle) is detected by the motion sensor(s) 22, causing the processor 30 to receive a first indication of a motion 301. In one mode of operation, the reception of the first indication 301 may generate a parameter space 302 in which a pause is expected. During this parameter space 302, the processor 30 may ignore other outputs (e.g., indications) from the motion sensor(s) 22. The width or required delay before accepting a subsequent indication from the motion sensor(s) 22 is illustrated by the width of the parameter space 302.

A subsequent timing window 305 illustrates the time period during which a second indication 304 from the motion sensor(s) 22 may be considered by the processor 30. That is, in this example, the second motion must be performed and/or received by the processor 30 during this timing window 305. If an indication of the motion is received before or after this timing window 305, it may not be used to determine a cooking instruction 38 (e.g., the indication may be ignored).

A further subsequent timing window 307 illustrates the time period during which a third indication 308 from the motion sensor(s) 22 may be considered by the processor 30. That is, in this example, the third motion must be performed and/or received by the processor 30 during this timing window 307. If an indication of the motion is received before or after this timing window 307, it may not be used to determine a cooking parameter 38 (e.g., the indication may be ignored).

The width of the parameter space 302/timing window 305/timing window 307 may be defined by the motion list 40, or pre-programmed into the processor 30. Furthermore, the parameter space 302/timing window 305/timing window 307 may be initiated and/or defined by the previous recognized movement. There may also be an additional optional parameter space or delay window (such as regions 303 and 306) between regions 302/305 and also between regions 305/307, respectively. During these optional parameter spaces 303 and 306, the processor 30 may ignore outputs (e.g., indications) from the motion sensor(s) 22.

Each of the indications 301, 304, and 308 may be used by the processor 30 to determine a particular cooking instruction 38. For example, if each of the indications 301, 304, and 308 match the motions associated with a particular cooking instruction 38, the processor 30 may determine that the user has used these motions to request that cooking instruction 38. The processor may then transmit the cooking instruction for performance, as is seen in FIG. 2B as command signal 309. On the other hand, if one or more of the indications 301, 304, and 308 do not match the motions associated with a particular cooking instruction 38, the processor 30 may determine that the user has entered a faulty instruction (or that the motion sensor(s) 22 have detected a false input). As such, the command signal 309 may not be sent out.

The outputs of the motion sensor(s) 22 (e.g., the indications of a detected motion) may have an associated minimum threshold of magnitude and direction of movement before it is recognized by the processor 30. Furthermore, while the processor 30 can be programmed to require any number and combination of movements before the processor 30 can determine a cooking instruction and send command signal 309, it may be desirable to use as few as possible for simplicity of the users. It may also be desirable to require specific types of movement to occur in sequence. Furthermore, other characteristics of the movement (such as direction, repetition, etc.) can also be used when matching the movements to a particular cooking instruction 30 (or determining a false input).

FIG. 3 illustrates another example cooking system 110 that may assist a user in cooking a food item (such as a steak). As is illustrated, the cooking system 110 includes a cooking device 18 (e.g., a cooking pan) that has one or more motion sensors 22 that may detect a motion associated with the cooking device 18 (e.g., a rotation of the cooking device 18). The cooking system 110 further includes a wireless device 114 (e.g., a mobile phone or tablet) that may execute an electronic cookbook 130. The electronic cookbook 130 may display portions of a cooking recipe that may be used to cook the food item.

The cooking system 110 of FIG. 3 may allow a user to utilize the cooking device 18 to change one or more parameters associated with cooking with the wireless device 114. For example, the cooking system 110 may allow the user to utilize the cooking device 18 to change a graphical user interface displayed on the wireless device 114, so as to assist in the cooking process. To do so, the user may perform one or more motions associated with the cooking device 18. For example, the user may tap on a portion of the cooking device 18 (e.g., tap on the handle of the cooking pan). The motion sensors 22 may sense (or otherwise detect) these motions, and a processor 30 of cooking device 18 may determine that these motions are an instruction from the user (e.g., an instruction to move to the next step in the displayed cooking recipe). Based on the determination, the processor 30 may send a device instruction 138 to the wireless device 114, causing the wireless device 114 to perform the device instruction 138 (e.g., move to the next step in the displayed cooking recipe).

The cooking system 110 may allow the cooking device 18 to replace or supplement the controls on a conventional wireless device 114. As a result, the user may be able to control the wireless device 114 (and electronic cookbook 130) without having to touch the wireless device 114. For example, if the user taps on a portion of the cooking device 18 three successive times, the motions may be an instruction from the user that causes the wireless device 114 to change to a successive step in a displayed cooking recipe. This may prevent the user from having to let go of the cooking device 18 while cooking. Also, it may prevent the user from having to touch the wireless device 114 with soiled hands from cooking. As such, the wireless device 114 may stay cleaner.

As is illustrated, the cooking system 110 includes a cooking device 18 and a network 42. The cooking device 18 and the network 42 of FIG. 3 may be substantially similar, respectively, to the cooking device 18 and network 42 of FIGS. 1A-1B, discussed above in detail. However, instead of memory 34 of the cooking device 18 including cooking instructions 38 and motions 40, the memory 34 of the cooking device 18 of FIG. 3 may alternatively (or additionally) include device instructions 138 and motions 140.

Device instructions 138 represent any set of instruction(s) that may be utilized by the wireless device 114 to assist the user in cooking. For example, the device instructions 138 may be an instruction associated with the electronic cookbook 130. Such instructions may include an instruction to move to the next step in the displayed cooking recipe, an instruction to move to a previous step in the displayed cooking recipe, an instruction to display a different portion of the cooking recipe, an instruction to move to a different recipe, an instruction to display a particular recipe (e.g., via selection of the recipe), an instruction to play a video associated with a recipe or a cooking technique, an instruction to display a picture associated with a recipe or a cooking technique, an instruction to advance a computer graphic user interface to a different display state, an instruction to scroll through the recipe or through any other graphic displayed by the wireless device 114, an instruction to activate a graphical user icon displayed by the wireless device 114, any other type of instruction associated with the electronic cookbook 130, or any combination of the preceding.

As another example, the device instruction 138 may be an instruction associated with the wireless device 114. Such instructions may include an instruction to turn on (or off) the electronic cookbook 130, an instruction to turn on (or off) any other application of the wireless device 114, an instruction to make a phone call, an instruction to take a photograph (or video), an instruction to transmit information to another device (such as the heat source system 46 of FIGS. 1A-1B), an instruction to initiate and/or acknowledge a wireless signal that pairs the cooking device 18 to the wireless device 114 or other device (such as the heat source system 46 of FIGS. 1A-1B), any other type of instruction associated with the wireless device 114, or any combination of the preceding. As a further example, the device instruction 138 may be any other instruction that may be utilized by the wireless device 114 to assist the user in cooking, or any combination of the preceding.

Motion list 140 represents any listing of motion(s) that may be utilized by the processor 30 to determine which device instruction 138 has been requested by a user. The motion list 140 may be substantially similar to the motion list 40 of FIGS. 1A-1B; however, the motion list 140 may be directed to device instructions 138 (instead of cooking instructions 38). In some examples, the motion list 140 may include the motion list 40 (or vice versa). As such, the motion list 140 (or the motion list 40) may be utilized by the processor 30 to determine which cooking instruction 38 or which device instruction 138 has been requested by a user. Furthermore, any of the details discussed above in FIGS. 1A-1B with regard to motions and cooking instructions 38 may similarly apply to device instructions 138. For example, any type of motion may be associated with a particular device instruction 138, and/or any number of motions (including sequences of motions) may be associated with a particular cooking instruction 138.

The cooking system 110 may further include the wireless device 14. Wireless device 14 represents any suitable components that may communicate with a user so as to provide cooking information (such as cooking recipes) to the user. Wireless device 14 may be a laptop, a mobile telephone or cellular telephone (such as a Smartphone), an electronic notebook, a tablet (such as an iPad), a personal digital assistant, a video projection device, any other device capable of receiving, processing, storing, and/or communicating information with other components of system 110, or any combination of the preceding. As is illustrated in FIG. 3, the wireless device 114 is a tablet. Furthermore, as illustrated, the wireless device 114 includes one or more network interfaces 118, one or more processors 122, and one or more memory units 126.

Network interface 118 represents any suitable device operable to receive information from network 42, transmit information through network 42, perform processing of information, communicate with other devices, or any combination of the preceding. For example, network interface 118 receives device instructions 138 from the cooking device 18. Network interface 118 represents any port or connection, real or virtual, (including any suitable hardware and/or software, including protocol conversion and data processing capabilities, to communicate through a LAN, a MAN, a WAN, or other communication system) that allows wireless device 114 to exchange information with network 42, cooking device 18, or other components of system 110.

Processor 122 communicatively couples to network interface 118 and memory unit 126, and controls the operation and administration of wireless device 114 by processing information received from network interface 118 and memory unit 126. Processor 122 includes any hardware and/or software that operates to control and process information. For example, processor 122 executes an electronic cookbook 130 to control the operation of wireless device 114, such as to cause the wireless device 114 to communicate with a user so as to provide cooking information (such as cooking recipes) to the user, and to further communicate with the cooking device 18 to assist the user in cooking. Processor 122 may be a programmable logic device, a DSP, a microcontroller, a microprocessor, a PLC, a controller, a logic circuit, an analog controller, any other processing device or the like, or any combination of the preceding

Memory unit 126 stores, either permanently or temporarily, data, operational software, or other information for processor 122. Memory unit 126 includes any one or a combination of volatile or non-volatile local or remote devices suitable for storing information. For example, memory unit 126 may include RAM, ROM, magnetic storage devices, optical storage devices, any other suitable information storage device, or any combination of the preceding. While illustrated as including particular information modules, memory unit 126 may include any suitable information for use in the operation of wireless device 114.

As illustrated, memory unit 126 includes the electronic cookbook 130. Electronic cookbook 130 represents any suitable set of instructions, logic, or code embodied in a computer-readable storage medium and operable to facilitate the operation of wireless device 114 with regard to cooking and/or the electronic cookbook 130. Examples details regarding electronic cookbook 130 are discussed below. Memory unit 126 may further include any other suitable set of instructions, logic, or code embodied in computer-readable storage medium and operable to facilitate other operations of wireless device 114, such as a telephone function of the wireless device 114, any other Smartphone or tablet function of the wireless device 114, any other function of the wireless device 114, or any combination of the preceding.

The electronic cookbook 130 may provide the user with instructions (and other content) associated with cooking. For example, the electronic cookbook 130 may provide the user with one or more cooking recipes and additional content that may assist the user in cooking a food item (such as a steak or chili). In some examples, the electronic cookbook 130 may be an “app” installed on the wireless device 114.

The electronic cookbook 130 may utilize a display screen of the wireless device 114 (or any other device in communication range of the wireless device 114) to allow a user to easily view, receive, or play the recipe instructions. To do so, the display screen may display a graphical user interface that includes the recipe instructions and/or any other information of the electronic cookbook 130.

When executed by the wireless device 114, the electronic cookbook 130 may display content associated with cooking in one or more graphical user interfaces. The user may navigate through the electronic cookbook 130 in order to select a particular cooking recipe to be used to cook a food item. Once a particular recipe (such as a recipe for chili, for example) has been selected, the electronic cookbook 130 may display on the wireless device 114 the cooking recipe associated with the selected food item. The electronic cookbook 130 may display the entire cooking recipe on the wireless device 114, or only a portion of the cooking recipe on the wireless device 114.

The cooking recipe may include any information that may be utilized in cooking the food item, such as steps (or stages) for preparing the food item, a list of ingredients for the food item, a list of quantities of ingredients for the food item, a list of substitute ingredients for the food item, a list of devices or appliances that may be used to cook the food item (such as a description and/or picture of a particular pot/pan, a description and/or picture of a particular type of appliance (such as an oven or grill) that should be used to cook the food item, etc.), any other information associated with the food item, or any combination of the preceding. The cooking recipe may also include instructional videos associated with cooking the food item and/or pictures associated with ingredients of the food item (such as a picture of an onion, a picture of a diced onion, a picture of what an onion looks like after being caramelized, etc.).

The electronic cookbook 130 may further include a step-by-step guide for cooking the food item in accordance with the cooking recipe. This step-by-step guide may navigate the user through each step in the cooking process. For example, the cooking recipe for chili may include the following steps: (1) meat is added to the pot and browned at a particular temperature (such as 375° F.) for a particular duration of time (such as 10 minutes); (2) onions and or other ingredients are added to the browned meat; (3) this combination of ingredients is cooked at a second particular temperature (such as 300° F.) for a second particular duration of time (such as 5 minutes); (4) tomatoes, tomato sauce, and spices are added; (5) this combination of ingredients is cooked at a third particular temperature (such as 212° F.) for a third particular duration (till the tomato sauce combination is reduced by ½); and (6) the entire food item is cooked at a fourth temperature (such as 180° F.) for a fourth particular duration of time (such as 4 hours).

In the step-by-step guide, each of the above example steps for chili may be displayed individually (or individually highlighted in the cooking recipe to identify the current step). For a current step, the wireless device 114 may display information that explains the current step in the cooking recipe, and further explains what the user is supposed to do during that step. Once the step has been completed, the user may be prompted to indicate that the step has been completed, such as by clicking on a “next” button displayed on the wireless device 114. This may allow the user to navigate to the next step. The user may click on a button of the wireless device 114 or the screen of the wireless device 114 to activate such a “next” button. Additionally (or alternatively), the user may perform one or more motions using the cooking device 18 to activate such a “next” button, or to otherwise navigate through the steps (or stages).

Additional information regarding the electronic cookbook 130 is discussed in detail in U.S. Patent Application Publication No. 2017/0238749 (the entirety of which is incorporated herein by reference). The electronic cookbook 130 and/or the wireless device 114 may have any of the functionalities discussed in U.S. Patent Application Publication No. 2017/0238749.

Modifications, additions, and/or substitutions may be made to the cooking system 110, the components of the cooking system 110, and/or the functions of the cooking system 110 without departing from the scope of the specification. For example, the cooking system 110 of FIG. 3 may include (or be combined with) the cooking system 10 of FIGS. 1A-1B. In such an example, the user may use the motion(s) associated with the cooking device 18 to control the heat source system 46, the heat source 50, the wireless device 114, and/or the electronic cookbook 130. As another example, although cooking system 110 is described above as including a wireless device 114, the device 114 may be any other type of electronic device (e.g., a personal computer, a television, a refrigerator or other apparatus with a display screen, etc.), including wired devices.

As one example of operation of FIG. 3, a user may desire to cook a food item, such as a steak. When cooking the food item, the user may desire to change a parameter associated with a wireless device 114 they are using to assist them in cooking. For example, the user may desire to move to the next step in a displayed cooking recipe, move to a previous step in the displayed cooking recipe, or play (or re-play) a video that explains a particular step in detail. Unfortunately, the user may not desire to change the parameter manually (e.g., the user's hands may be dirty or may be full from holding cooking devices). Instead, the user may perform one or more motions associated with the cooking device 18. For example, the user may tap on a portion of the cooking device 18 (e.g., tap on the handle of the cooking pan).

The motion(s) performed by the user may be any type of motion, or any sequence of motions. Furthermore, the motion(s) may have any of the characteristics (e.g., direction of movement) discussed above with regard to FIGS. 1A-1B. The motion(s) may be a set of one or more motions that represent a device instruction 138 that is to be performed as a result of the motion(s). Thus, the user may perform a particular set of motion(s) in order to cause a particular device instruction 138 to be performed.

As a result of performing the one or more motions, the motion sensor(s) 22 of the cooking device 18 may sense (or otherwise detect) the performed motions. The motion sensor(s) 22 may then transmit an indication of the detected motion to the processor 30. Following transmittal of the indication of the detected motion, the processor 30 may receive the indication and may determine the device instruction 138 based on the indication. The processor 30 may determine the device instruction 138 in any manner based on the indication. For example, the processor 30 may compare the received indication(s) to the motion list 140 to determine a match. If the received indication (e.g., a tap on the handle) matches a particular stored motion (e.g., a tap on the handle), the motion list 140 may further identify the device instruction 138 to be performed (e.g., move to the next step).

The processor 30 may determine the cooking instruction 38 using any number of indications received from the motion sensor(s) 22, and may determine the device instruction 138 in any manner based on the indications. Example details regarding the indications and the determination of instructions based on the indications are discussed above with regard to FIGS. 1A-1B.

Following the determination of a device instruction 138, the user interface system 28 of the cooking device 18 may provide an output to the user. The output may be any type of output that may provide information to the user. As an example, the output may indicate that the user's motion(s) have been detected, that a particular device instruction 138 has been determined, that the particular device instruction 138 has been transmitted for performance, or any other indication associated with system 110. The output may be provided in any manner and may be provided by any type of user interface system 28.

Also following the determination of a device instruction 138, the processor 30 may transmit the device instruction 138 for performance. The device instruction 138 may be transmitted to any element of system 110 to cause the device instruction 138 to be performed. For example, the device instruction 138 may be transmitted directly to the wireless device 114, so as to cause the wireless device 114 to perform the device instruction 138 (e.g., move to the next step or portion in the displayed recipe). As a further example, the device instruction 138 may be transmitted to an intermediary device (e.g., the heat source system 46), which may re-transmit the device instruction 138 to the wireless device 114.

The device instruction 138 may be performed in accordance with the device instruction 138. For example, if the device instruction 138 is to move to the next step or portion in the displayed recipe, the display of the wireless device 114 may display the next step or portion of the recipe. To do so, the wireless device 114 may change the displayed graphical user interface so that it moves from the first step (or first portion) of the cooking recipe to the second step (or second portion) of the cooking recipe.

Any number of device instructions 138 may be performed using the system 110 of FIG. 3. For example, an entire cooking recipe may be scrolled through (and the user may cook the recipe) using only the motions associated with the cooking device 18. In such an example, the electronic cookbook 130 may be turned on, a recipe may be selected, each of the steps of the recipe may be scrolled through, and the electronic cookbook 130 may be turned off, all without the user having to touch the wireless device 114.

Modifications, additions, or omissions may be made to the example discussed above. As a first example, the operation of FIG. 3 may include any of the details (e.g., details regarding motions), steps, and/or functions discussed above with regard to the example of operation of FIGS. 1A-1B. In such an example, a first set of motion(s) may be used to control the heat source system 46 (and/or heat source 50), while a second set of motions(s) may be used to control the wireless device 114 (and/or electronic cookbook 130). As another example, the user interface system 28 (e.g., display) of the cooking device 18 may not provide any output to the user. Instead, the output may be provided by the wireless device 114, or it may not be provided at all. Additionally, the steps of the example may be performed in parallel or in any suitable order.

In some examples, the cooking device 18 of FIGS. 1A-1B and/or FIG. 3 may further include a NFC transmitter/receiver/transceiver (or a radio frequency identification (RFID) tag) to allow for pairing and communication with the heat source system 46, heat source 50, wireless device 114, or any other device. Furthermore, it may also allow for identification of the wireless device 114. Also, the heat source system 46 and/or the wireless device 114 (and/or any other device) may have a corresponding NFC transmitter/receiver/transceiver in order to transmit and receive NFC communications to and from the cooking device 18.

By utilizing near field communications, the heat source system 46 (or wireless device 114) may be operated more safely and/or efficiently, in some examples. For example, when the cooking device 18 is in sufficient proximity for near field communication, the heat source 50 of the heat source system 46 may receive and/or perform commands transmitted by the cooking device 18 (e.g., in response to motions made by the user). However, when the cooking device 18 moves out of sufficient proximity for near field communication, the heat source 50 may be de-energized (or may be de-energized after a pre-determined amount of time after the cooking device 18 moves out of sufficient proximity), in some examples. This may prevent the heat source 50 from accidentally continuing to provide energy after the cooking device 18 has been moved by the user (e.g., when the cooking device 18 is removed from the heat source 50 because the food item is done cooking).

Furthermore, in some examples, the heat source 50 may be de-energized after movements of the cooking device 18 stop while the cooking device 18 is in proximity for near field communications. For example, in the case of a recipe for a food item (e.g., a sauce) that requires continuous stirring in a certain temperature range, the motion sensor(s) 22 of the cooking device 18 (e.g., a stirring utensil) may be used to detect a continuous stirring motion. When the stirring motion stops (or stops longer than a predetermined period of time), the heat source 50 may be de-energized, brought into a low power mode, or the temperature of the heat source 50 may be turned down. This change in the energy provided by the heat source 50 may be caused by a signal from the cooking device 18 when active stirring is no longer detected by the motion sensor(s) 22. In other examples, the change in the energy provided by the heat source 50 may be caused by a signal from a wireless device 114 acting as an intermediary between the cooking device 18 and the heat source system 46.

In some examples, near field communications may also be used to select a particular heat source system 46 (or heat source 50, or wireless device 114) to control using a cooking device 18. For example, when a heat source system 46 has multiple heat sources 50 (e.g., multiple burners), the near field communications may allow a particular heat source 50 to be selected. Such a selection may occur in any manner. Furthermore, such a selection may be based on the number of NFC receivers included in the heat source system 46 (or other device).

For example, a heat source system 46 having multiple heat sources 50 may also have multiple NFC receivers (e.g., an NFC receiver for each particular heat source 50). In such an example, an NFC receiver may be positioned in a location proximate to each heat source 50. This may allow a particular heat source 50 to be selected (e.g., for use to cook a food item) when a user waives the cooking device 14 (e.g., a utensil) over the NFC receiver associated with the particular heat source 50.

Alternatively, a heat source system 46 having multiple heat sources 50 may also have only a single NFC receiver (or the heat source system 46 may be in communication with a wireless device 114 that has only a single NFC receiver). In such an example, a particular heat source 50 of the heat source system 46 may be selected (e.g., for use to cook a food item) when the user performs one or more motions associated with the particular heat source 50. For example, the user may tap on the handle of the cooking device 18 three times in order to select the third heat source 50. As another example, the user may perform a pattern of movement to select a particular heat source 50, such as a single tap on the heat source system 46 using the cooking device 18, followed by moving the cooking device 18 towards the desired heat source 50. In such an example, the original tap on the heat source system 46 may be made in a location having a central location between all of the heat sources 50, for example.

In some examples, near field communications may also be used to establish indirect communications between a cooking device 18 and a heat source system 46 (or other device). For example, as is discussed above, a wireless device 114 (or other device) may operate as an intermediary by receiving the cooking instructions 38 sent by the cooking device 18 and re-transmitting them to the heat source system 46 and/or heat source 50. In such examples, the near field communication may be used to establish such communications.

For example, the cooking device 18 may have a NFC transmitter/receiver/transceiver that can pair with and communicate with a corresponding NFC transmitter/receiver/transceiver included in the wireless device 114 (e.g., a Smartphone or tablet computer). In addition to being able to communicate with the cooking device 18, the wireless device 114 may also be able to communicate with the heat source system 46. The cooking device 18 and the wireless device 114 may communicate using a protocol that requires very close proximity between the two devices (e.g., a distance of a few inches or a few feet). Furthermore, the wireless device 114 and the heat source system 46 may communicate using this same protocol, or they may communicate using a different protocol or longer range communication protocol (e.g., low power Bluetooth). In such examples, when the cooking device 18 moves into sufficient proximity for near field communication with the wireless device 114, the wireless device 114 may respond by automatically establishing communications (e.g., Bluetooth communications) with the heat source system 46. When this is established, the wireless device 114 may operate as an intermediary between the cooking device 18 and the heat source system 46.

This specification has been written with reference to various non-limiting and non-exhaustive embodiments or examples. However, it will be recognized by persons having ordinary skill in the art that various substitutions, modifications, or combinations of any of the disclosed embodiments or examples (or portions thereof) may be made within the scope of this specification. Thus, it is contemplated and understood that this specification supports additional embodiments or examples not expressly set forth in this specification. Such embodiments or examples may be obtained, for example, by combining, modifying, or reorganizing any of the disclosed steps, components, elements, features, aspects, characteristics, limitations, and the like, of the various non-limiting and non-exhaustive embodiments or examples described in this specification. In this manner, Applicant reserves the right to amend the claims during prosecution to add features as variously described in this specification.

What is claimed is:

1. A system, comprising:
a. a cooking device operable to be used to cook a food item, the cooking device comprising one or more motion sensors operable to detect a motion associated with the cooking device;
b. a wireless device operable to display a cooking recipe in a graphical user interface; and
c. one or more processors communicatively coupled to the one or more motion sensors, and operable, when executed, to:
i. receive one or more indications of a detected motion associated with the cooking device; and
ii. based on the one or more indications, determine a device instruction;
d. wherein the wireless device is further operable to perform the determined device instruction.

2. The system of claim 1, wherein the wireless device is further operable to change the displayed graphical user interface from a first portion of the cooking recipe to a second portion of the cooking recipe in accordance with the determined device instruction.

3. The system of claim 1, wherein the one or more indications of a detected motion associated with the cooking device comprise:
a. a first indication of a first detected motion; and
b. a second indication of a second detected motion.

4. The system of claim 3, wherein the one or more processors are further operable, when executed, to:
a. determine whether the second indication was received within a predetermined amount of time after receipt of the first indication;
b. in response to the determination that the second indication was received within the predetermined amount of time, determine the cooking instruction based on the first indication and the second indication.

5. The system of claim 1, wherein the cooking device is a cooking pot, a cooking pan, or a cooking utensil.

6. The system of claim 1, wherein cooking device further comprises the one or more processors.

7. The system of claim 1, wherein the motion associated with the cooking device is a tap by a user on a portion of the cooking device, a shake of the cooking device, a rotation of the cooking device, or a stop of movement of the cooking device.

8. The system of claim 1, wherein the wireless device comprises the one or more processors.

9. The system of claim 1, wherein the determined device instruction is an instruction move from a first portion of the cooking recipe to a second portion of the cooking recipe, an instruction to move from a second portion of the cooking recipe to a first portion of the cooking recipe, an instruction to display a different cooking recipe, an instruction to play a video associated with the cooking recipe, or an instruction to stop displaying the cooking recipe.

10. A method, comprising:
a. detecting, by one or more motion sensors of a cooking device, one or more motions associated with the cooking device, wherein the cooking device is operable to be used to cook a food item;
b. receiving, by one or more processors communicatively coupled to the one or more motion sensors, one or more indications of the detected motions associated with the cooking device; and
c. based on the one or more indications, determining, by the one or more processors, a device instruction, wherein the determined device instruction is configured to cause a wireless device to perform an action in accordance with the determined device instruction.

11. The method of claim 10, wherein the determined device instruction is configured to cause a wireless device to change a displayed graphical user interface from a first portion of a cooking recipe to a second portion of the cooking recipe in accordance with the determined device instruction.

12. The method of claim 10, wherein the one or more indications of the detected motions associated with the cooking device comprise:
a. a first indication of a first detected motion; and
b. a second indication of a second detected motion.

13. The method of claim 12, further comprising:
a. determining, by the one or more processors, whether the second indication was received within a predetermined amount of time after receipt of the first indication; and
b. in response to the determination that the second indication was received within the predetermined amount of time, determining, by the one or more processors, the cooking instruction based on the first indication and the second indication.

14. The method of claim 10, wherein the cooking device is a cooking pot, a cooking pan, or a cooking utensil.

15. The method of claim 10, wherein the one or more motions associated with the cooking device is a tap by a user on a portion of the cooking device, a shake of the cooking device, a rotation of the cooking device, or a stop of movement of the cooking device.

16. A cooking device, comprising:
a. a handle operable to be grasped by a user;
b. one or more motion sensors operable to detect a motion associated with the cooking device; and
c. one or more processors communicatively coupled to the one or more motion sensors, and operable, when executed, to:
i. receive one or more indications of a detected motion associated with the cooking device; and
ii. based on the one or more indications, determine a device instruction, wherein the determined device instruction is configured to cause a wireless device to perform an action in accordance with the determined device instruction.

17. The cooking device of claim 16, wherein the determined device instruction is configured to cause the wireless device to change a displayed graphical user interface from a first portion of a cooking recipe to a second portion of the cooking recipe in accordance with the determined device instruction.

18. The cooking device of claim 16, wherein the cooking device is a cooking pot, a cooking pan, or a cooking utensil.

19. The cooking device of claim 16, further comprising a display that is operable to provide a visual indication associated with the determined cooking instruction.

20. The cooking device of claim 16, wherein the one or more processors are positioned on or in the handle.
